(19) United States
(12) Patent Application Publication
(10) Pub. No.: US 2010/0242640 A1
(43) Pub. Date: Sep. 30, 2010

(54) Vibrator Assembly having a Cylindrical Unbalanced Counterweight

(75) Inventors: Michael J Salamone, Arlington Heights, IL (US); David A. Brewer, Mundelein, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg (IL)

(21) Appl. No.: 12/409,969

(22) Filed: Mar. 24, 2009

(51) Int. Cl. B06B 1/16

(52) U.S. Cl. 74/61

(57) ABSTRACT

Disclosed is a vibrator assembly having a cylindrical counterweight with an unbalanced core. A conductive shield the length of the unbalanced rotatable counterweight is positioned about the length of the unbalanced rotatable counterweight, the conductive shield having a shield axis along the rotatable axis. The shield is a cylinder, a portion of a cylinder, or another form of a hollow structure. The shield can be, for example, welded, tightly fitted, or glued to the rotary vibrator assembly. In another embodiment, the conductive shield and unbalanced rotatable counterweight are a single component. In another embodiment, the assembly can include an end cap at a distal end of the shield. In still another embodiment, a circuit element can be electrically connected to the conductive shield.

### FIELD

Disclosed is a vibrator assembly having a cylindrical counterweight with an unbalanced core.

### BACKGROUND

The makers of mobile communication devices, including those of cellular telephones, are increasingly adding functionality to their devices. For example, cellular telephones can include several antennas that are used to send and receive signals according to different frequencies such as multiple cellular frequency bands used through the world, both primary and diversity receivers, WiFi, WLAN, Bluetooth, and GPS. While there is a trend toward the inclusion of more features and improvements for current features, there is also a trend toward smaller mobile communication devices.

As mobile communication device technology has continued to improve, the devices have become increasingly smaller. Fewer and/or smaller hardware and software components are therefore desirable when adding new features and making improvements to the current features in the smaller devices. Moreover, the arrangement of components can become critical as certain components may have an impact on the operation or efficiency of other components.

### BRIEF DESCRIPTION OF THE DRAWINGS

FIG. 1 depicts an embodiment of a rotary vibrator assembly having an unbalanced counterweight in a first position proximal an antenna;

FIG. 2 depicts an embodiment of a rotary vibrator assembly having an unbalanced counterweight in a second position proximal an antenna;

FIG. 3 depicts an embodiment of a vibrator assembly having a cylindrical counterweight with an unbalanced core;

FIG. 4 depicts an embodiment of a vibrator assembly having a cylindrical counterweight with an unbalanced core wherein the conductive shield and unbalanced rotatable counterweight are a single component;

FIG. 5 depicts an embodiment of a vibrator assembly having a cylindrical counterweight having an end cap at a distal end of the shield;

FIG. 6 depicts an embodiment of a shield that is a hollowed or multi-sided structure.

FIG. 7 depicts an embodiment of a shield that is a cylinder with scores;

FIG. 8 depicts an embodiment of a shield including holes or perforations;

FIG. 9 depicts an embodiment of an end view of a counterweight with significant mass/inertia and a cylindrical shield and between the counterweight and a cylindrical shield where there might otherwise be a hollow space or a portion of the core is filled with a low-density, low-inertia substance; and

FIG. 10 depicts an embodiment of an end view of a counterweight and a core that could be filled with a low-density, low-inertia substance where the shield is a portion of a cylinder.

### DETAILED DESCRIPTION

Antennas are particularly sensitive to electromagnetic changes in their environment. The performance of antennas can be degraded by the presence of certain objects in close proximity such as metallic objects that are not part of the antenna system. It is sometimes possible to tune an antenna to overcome the presence of such an object that interferes with its performance when the position of the object is fixed.

Miniature vibrator assemblies, including rotary vibrator assemblies, are common in miniature electronic devices such as mobile communication devices. Rotary vibrator assemblies generate vibration by rotating an unbalanced counterweight at high RPM. The degree of vibration is generally proportional to the degree of unbalanced loading. Rotary vibrators assemblies and antennas are two components that frequently restrict the layout and shape of mobile communication devices because of the large space they occupy relative to most other components and because of the need to isolate them from other components including each other. For example, the performance of antennas can be degraded by the proximity of the counterweight to the antenna. It would be beneficial if a rotary vibrator assembly could be placed in close proximity to an antenna without causing continuously variable detuning of the proximal antenna.

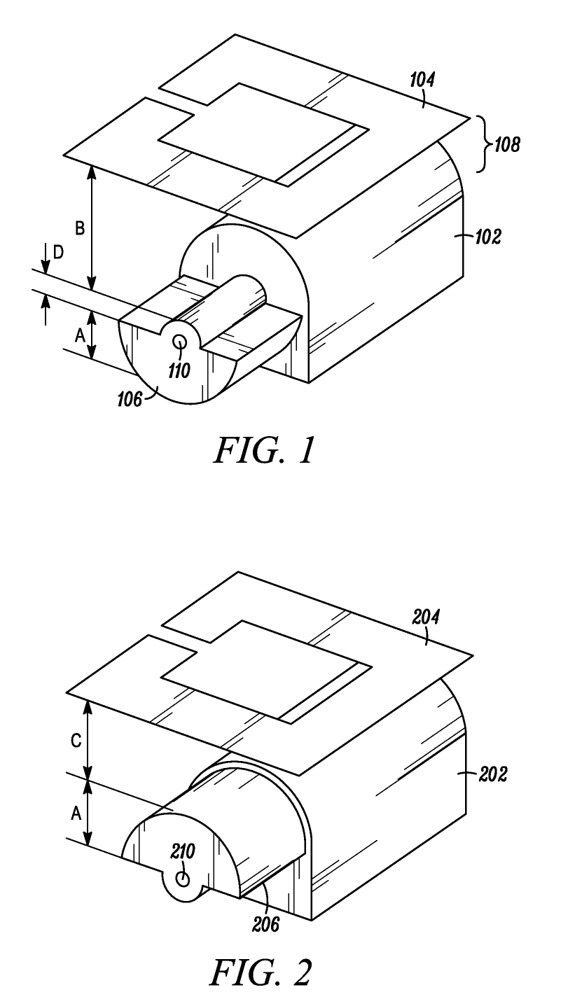

FIGS. 1 and 2 depict an embodiment of a rotary vibrator assembly 102 (202) proximal an antenna 104 (204). The radius or height of exemplary counterweight 106 is “A” and there is a distance “B” between the top of the depicted rotatable counterweight 106 and the antenna 104. Distance “D” represents the distance between the rotatable axis of the exemplary counterweight 106 and the top of the depicted rotatable counterweight. The configuration including radius or height A, distance B, and distance D can also include distance 108 between the top of the assembly 102 and the antenna 104. It is understood that the configuration shown in FIGS. 1 and 2 are exemplary and can depend upon the design, positions, and tolerances of the assembly 102 and the antenna 104 which can be determined by the manufacturer and sub-contractors.

A rotatable counterweight 106 on the rotary vibrator assembly 102 can degrade the antenna's 104 performance and prohibit effective tuning of the antenna since the angular position of the counterweight 106 changes randomly after every use and even between uses. FIG. 1 depicts the counterweight 106 at a low position about the rotatable axis 110. FIG. 2 depicts the counterweight 206 in an upper position about the rotatable axis 210.

As depicted in FIG. 1, when the counterweight 106 is in a low position, there is a distance “B” between the top of the depicted rotatable counterweight 106 and the antenna 104. As depicted in FIG. 2, when the counterweight 206 is in an upper position, there is a distance “C” between the top of the depicted counterweight 206 and the antenna (which can include distance 108 of FIG. 1). Distance “B” plus distance “D” is different from distance “C” by the radius or height “A” of the counterweight 106.

Disclosed is a vibrator assembly having a cylindrical counterweight with an unbalanced core. A conductive shield the length of the unbalanced rotatable counterweight is positioned about the length of the unbalanced rotatable counterweight, the conductive shield having a shield axis along the rotatable axis. The shield is a cylinder, a portion of a cylinder, or another form of a hollow structure. The shield can be, for example, welded, tightly fitted, or glued to the rotary vibrator assembly. In another embodiment, the conductive shield and unbalanced rotatable counterweight are a single component. In another embodiment, the assembly can include an end cap at a distal end of the shield. In still another embodiment, a circuit element can be electrically connected to the conductive shield.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

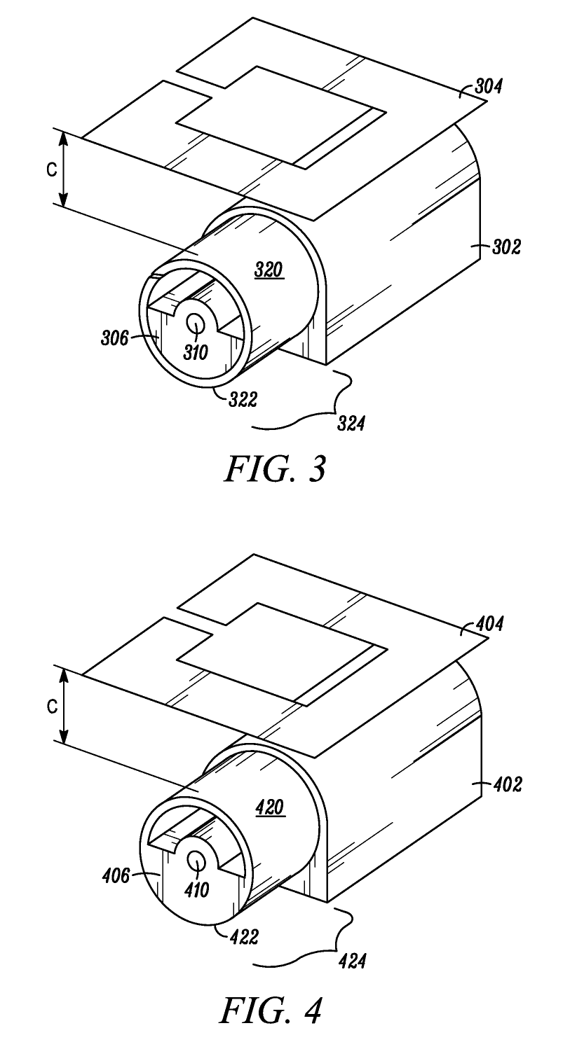

FIG. 3 depicts an embodiment of a vibrator assembly 302 having a cylindrical counterweight 320 with an unbalanced core 306. The disclosed cylindrical counterweight 320 having a cylindrical outer envelope 322 acts as a shield for the antenna 304 against the counterweight 306. The shield 322 is conductive. The conductive shield 322 has the length 324 of the unbalanced rotatable counterweight 306 and is positioned about the length 324 of the unbalanced rotatable counterweight 306. The combination of the counterweight 306 and the shield 322 with symmetry about its center axis, also referred to as a shield axis along the rotatable axis 310, generates unbalanced loading during rotation to cause vibration by the vibrator assembly 302.

When the vibrator assembly 302 is activated and the cylindrical counterweight is rotated, the shield has a constant influence over a proximal antenna 304 since it is always approximately the distance “C” from the antenna. Also, when the vibrator assembly is at rest with the cylindrical counterweight in any rest position, a low and a high position being depicted in FIGS. 1 and 2, the shield 322 has a constant influence over a proximal antenna 304 since it is always approximately the distance “C” from the antenna 304.

FIG. 4 depicts an embodiment of a vibrator assembly 402 having a cylindrical counterweight 420 with an unbalanced core 406 wherein the conductive shield 422 and unbalanced rotatable counterweight 406 are a single component 420. The conductive shield 422 portion of the single component 420 has the length 424 of the unbalanced rotatable counterweight 406 portion of the single component 420. When the vibrator assembly 402 is activated or at rest, the shield 422 has a constant influence over a proximal antenna 404 since it is always approximately the distance “C” from the antenna 404.

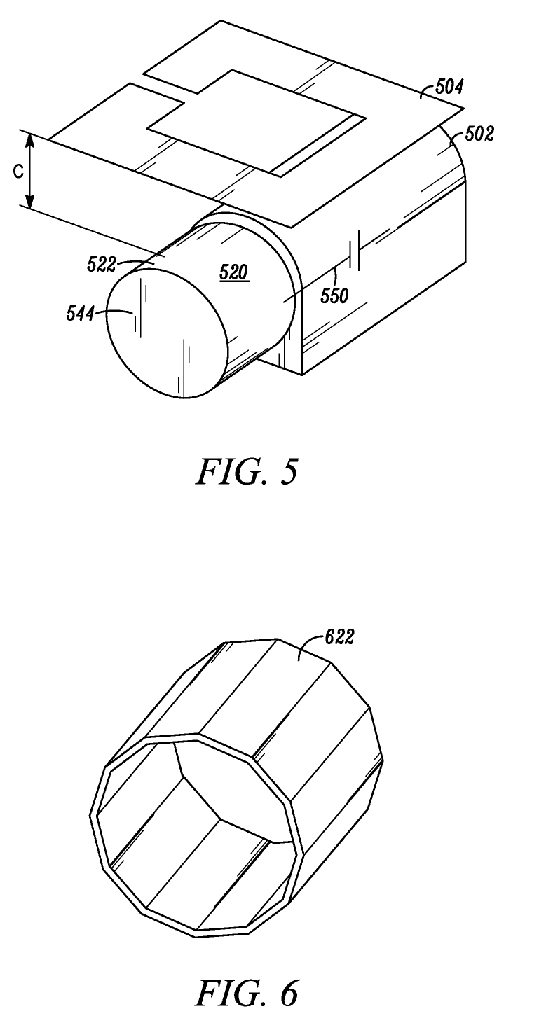

FIG. 5 depicts an embodiment of a vibrator assembly 502 having a cylindrical counterweight 520 having an end cap 544 at a distal end of the shield 522. The end cap 544 may provide further shielding of the antenna 504 from the counterweight (enclosed) allowing further freedom in the placement of the vibrator assembly 502 and antenna 504 components in a device. The end cap can also facilitate alignment between the shield and the core 406 in the direction of their rotatable axes.

As discussed above, the shield 522 is conductive. It is understood that the shield may be metallic or any other type of conductive material. A circuit element 550 may electrically connect the conductive shield 522 of the cylindrical counterweight 520 to another component of the assembly 502 or of the device. For example, such a circuit element 550 may provide a ground for the shield 522.

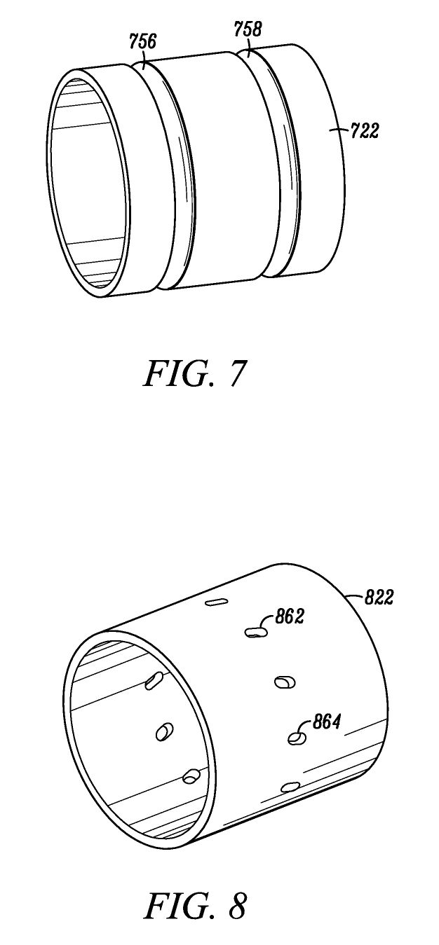

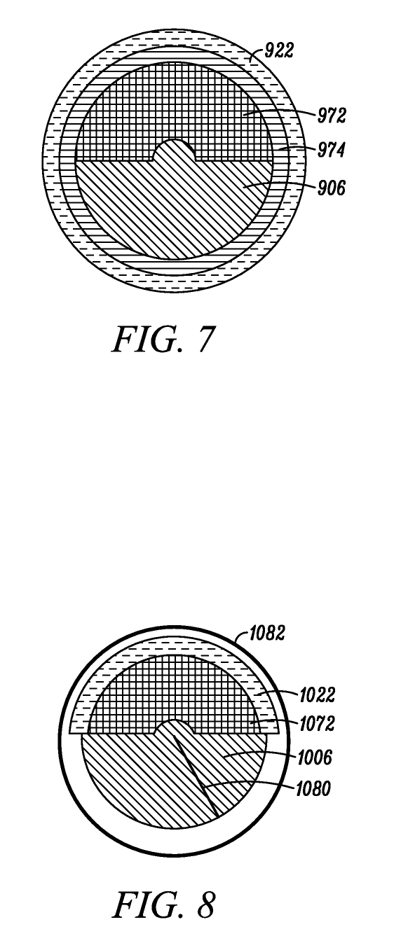

FIGS. 6, 7, and 8 depict embodiments of shields formed by different types of hollowed structures. FIG. 6 depicts an embodiment of a shield 622 that is a multi-sided structure. FIG. 7 depicts an embodiment of a shield 722 that is a cylinder with scores 756 and 758. FIG. 8 depicts an embodiment of a shield 822 including, for example, holes or perforations 862 and 864. It is understood that any variations of the shields of FIGS. 6, 7, and 8, including patterned, random, and in any arrangement are within the scope of this discussion. Furthermore, another shield shape may include a planar conductive shield member positioned between the unbalanced rotatable counterweight and the antenna. The shield may have less than the full length of the counterweight. In one embodiment, the conductive shield has dimensions to shield the antenna from the counterweight where the antenna exists above only a portion of the counterweight. Moreover, it is also understood that a conductive shield may be a portion of a hollow structure such as a portion of a cylinder.

In addition to being any suitable shape to provide substantially uniform shielding as described herein, it is understood that a shield may be incorporated into a vibrator assembly in any manner, such as by welding, tight fitting, and gluing. As described and depicted in FIG. 4, the shield 422 and the counterweight 406 are a single structure.

FIGS. 9 and 10 depict embodiments of a cylindrical counterweight whereby the shield may be a conductive coating or skin that may be applied in the manner, for example, of plating. FIG. 9 depicts an end view of an embodiment of a counterweight 906 having significant mass/inertia and a cylindrical shield 922. Between the counterweight 906 and a cylindrical shield 922 there might otherwise be a hollow space as shown by 972. Alternatively, a portion of the core could be filled with a low-density, low-inertia substance 972. In one embodiment, a nonconductive sheath 974 may be a carrier for a conductive coating that forms the shield 922. For example, the core 972 and the sheath 974 may be fabricated together as one piece through a molding operation.

FIG. 10 depicts an end view of an embodiment of a counterweight 1006 and a core 1072 that could be filled with a low-density, low-inertia substance. A conductive coating or skin may be applied to the core 1072 by, for example, plating to form a shield 1022. The shield 1022, for example, may form a portion of a cylinder. In other words, the conductive shield 1022 can be the length of the unbalanced rotatable counterweight and positioned about the length of the unbalanced rotatable counterweight (see FIGS. 3, 4, and 5) and at the radius 1080 of the counterweight 1006, essentially extending the circumference 1082 (approximately depicted for illustrative purposes) of the counterweight 1006.

In accordance with the disclosed cylindrical unbalanced counterweight of a rotary vibrator assembly, it is possible to place the rotary vibrator assembly in relatively close proximity to an antenna without causing continuously variable detuning of the proximal antenna. Therefore, the arrangement of such components is less critical since the vibrator assembly may have less impact on the operation or efficiency of a proximal antenna. Accordingly, there may be less restriction on the layout and shape of a mobile communication device

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A rotary vibrator assembly, comprising:
an unbalanced rotatable counterweight having a length and a rotatable axis; and
a conductive shield the length of the unbalanced rotatable counterweight and positioned about the length of the unbalanced rotatable counterweight, the conductive shield having a shield axis along the rotatable axis.

2. The assembly of claim 1, wherein the shield is a cylinder or a portion of a cylinder.

3. The assembly of claim 1, wherein the shield is a hollow structure.

4. The device of claim 1, wherein the shield is welded to the rotary vibrator assembly.

5. The device of claim 1, wherein the shield is tightly fitted to the rotary vibrator assembly.

6. The device of claim 1, wherein the shield is bonded to the rotary vibrator assembly by glue.

7. The device of claim 1, wherein the conductive shield and unbalanced rotatable counterweight are a single component.

8. The device of claim 1, further comprising:
an end cap at a distal end of the shield.

9. The device of claim 1, further comprising:
a circuit element electrically connected to the conductive shield.

10. A device, comprising:
an antenna;
a rotary vibrator assembly having an unbalanced rotatable counterweight having a length and having a rotatable axis, the unbalanced rotatable counterweight proximal to the antenna; and
a conductive shield positioned between the unbalanced rotatable counterweight and the antenna, the conductive shield having dimensions to shield the antenna from the counterweight.

11. The device of claim 10, wherein the conductive shield is the length of the unbalanced rotatable counterweight and positioned about the length of the unbalanced rotatable counterweight, the conductive shield having a shield axis along the rotatable axis.

12. The assembly of claim 10, wherein the shield is a cylinder or a portion of a cylinder.

13. The assembly of claim 10, wherein the shield is a hollow structure.

14. The device of claim 10, further comprising a circuit component electrically connecting the conductive shield to a component of the device.

15. A rotary vibrator assembly, comprising:
an unbalanced rotatable counterweight having a length and a rotatable axis, a radius from the rotatable axis, and occupying a portion of a circumference at the radius; and
a conductive shield the length of the unbalanced rotatable counterweight and positioned about the length of the unbalanced rotatable counterweight and at the radius of the counterweight, substantially extending the circumference of the counterweight.

16. The device of claim 10, wherein the shield has a shield axis along the rotatable axis.

17. The assembly of claim 17, wherein the shield is a cylinder or a portion of a cylinder.

18. The assembly of claim 17, wherein the shield is a hollow structure.
